(19) United States
(12) Patent Application Publication
(10) Pub. No.: US 2025/0162681 A1
(43) Pub. Date: May 22, 2025

(54) OPERATING DEVICE OF HUMAN-POWERED VEHICLE

(71) Applicant: SHIMANO INC., Sakai City (JP)

(72) Inventors: Kentaro KOSAKA, Sakai City (JP); Shuhei TAHARA, Sakai City (JP); Yoshimitsu MIKI, Sakai City (JP); Masaki DEGUCHI, Sakai City (JP)

(73) Assignee: SHIMANO INC., Sakai City (JP)

(21) Appl. No.: 18/516,967

(22) Filed: Nov. 22, 2023

(51) Int. Cl. B62K 23/02

(52) U.S. Cl. CPC B62K 23/02

(57) ABSTRACT

An operating device comprises a base structure, a circuit board, a first operating member, a second operating member, a third operating member, a first electric switch, a second electric switch, and a third electric switch. The circuit board includes a first surface and a second surface provided on a reverse side of the first surface. The first electric switch is configured to be activated in response to a movement of the first operating member. The second electric switch is configured to be activated in response to a movement of the second operating member. The third electric switch is configured to be activated in response to a movement of the third operating member. The first electric switch, the second electric switch, and the third electric switch are provided on the circuit board.

### BACKGROUND

### Technical Field

The present invention relates to an operating device of a human-powered vehicle.

### Background Information

A human-powered vehicle includes an operating device configured to operate at least one operated unit. The operating device includes at least two operating members. One of objects of the present disclosure is to simplify the structure of the operating device while improving flexibility of controlling another device using the at least two operating members. Another of objects of the present disclosure is to improve efficient arrangement of parts of the operating device while improving flexibility of controlling another device using the at least two operating members.

### SUMMARY

In accordance with a first aspect of the present invention, an operating device of a human-powered vehicle comprises a base structure, a circuit board, a first operating member, a second operating member, a third operating member, a first electric switch, a second electric switch, and a third electric switch. The base structure is mountable to the human-powered vehicle. The circuit board includes a first surface and a second surface provided on a reverse side of the first surface. The first operating member is movably coupled to the base structure. The second operating member is movably coupled to the base structure. The third operating member is movably coupled to the base structure. The first electric switch is configured to be activated in response to a movement of the first operating member. The second electric switch is configured to be activated in response to a movement of the second operating member. The third electric switch is configured to be activated in response to a movement of the third operating member. The first electric switch, the second electric switch, and the third electric switch are provided on the circuit board.

With the operating device according to the first aspect, since the first electric switch, the second electric switch, and the third electric switch are provided on the circuit board, it is possible to simplify the structure of the operating device while improving flexibility of controlling another device using the first electric switch, the second electric switch, and the third electric switch.

In accordance with a second aspect of the present invention, the operating device according to the first aspect is configured so that the first electric switch, the second electric switch, and the third electric switch are provided on the first surface.

With the operating device according to the first aspect, it is possible to reliably simplify the structure of the operating device while improving flexibility of controlling another device using the first electric switch, the second electric switch, and the third electric switch.

In accordance with a third aspect of the present invention, the operating device according to the first or second aspect is configured so that the first operating member is pivotally coupled to the base structure about a first pivot axis. The second operating member is pivotally coupled to the base structure about a second pivot axis.

With the operating device according to the third aspect, it is possible to make it easy for the user to operate the first operating member and the second operating member.

In accordance with a fourth aspect of the present invention, the operating device according to the third aspect is configured so that the second pivot axis is provided between the first electric switch and the second electric switch as viewed in a first direction perpendicular to the first surface.

With the operating device according to the fourth aspect, it is possible to efficiently arrange the first electric switch and the second electric switch.

In accordance with a fifth aspect of the present invention, an operating device of a human-powered vehicle comprises a base structure, a circuit board, a first operating member, a second operating member, a third operating member, a first electric switch, a second electric switch, and a third electric switch. The base structure is mountable to the human-powered vehicle. The circuit board includes a first surface and a second surface provided on a reverse side of the first surface. The first operating member is movably coupled to the base structure. The second operating member is movably coupled to the base structure. The third operating member is movably coupled to the base structure. The first electric switch is configured to be activated in response to a movement of the first operating member. The second electric switch is configured to be activated in response to a movement of the second operating member. The third electric switch is configured to be activated in response to a movement of the third operating member. The first operating member is pivotally coupled to the base structure about a first pivot axis. The second operating member is pivotally coupled to the base structure about a second pivot axis. The second pivot axis is provided between the first electric switch and the second electric switch as viewed in a first direction perpendicular to the first surface.

With the operating device according to the fifth aspect, it is possible to improve efficient arrangement of parts of the operating device while improving flexibility of controlling another device using the first electric switch, the second electric switch, and the third electric switch.

In accordance with a sixth aspect of the present invention, the operating device according to any one of the third to fifth aspects is configured so that the second pivot axis is provided between the second electric switch and the third electric switch as viewed in a first direction perpendicular to the first surface.

With the operating device according to the sixth aspect, it is possible to reliably improve efficient arrangement of parts of the operating device while improving flexibility of controlling another device using the first electric switch, the second electric switch, and the third electric switch.

In accordance with a seventh aspect of the present invention, the operating device according to any one of the third to sixth aspects is configured so that the first electric switch is at least partially provided between the first pivot axis and the second pivot axis as viewed in a first direction perpendicular to the first surface.

With the operating device according to the seventh aspect, it is possible to reliably improve efficient arrangement of parts of the operating device while improving flexibility of controlling another device using the first electric switch, the second electric switch, and the third electric switch.

In accordance with an eighth aspect of the present invention, the operating device according to any one of the third to seventh aspects is configured so that the third electric switch is at least partially provided between the first pivot axis and the second pivot axis as viewed in a first direction perpendicular to the first surface.

With the operating device according to the eighth aspect, it is possible to reliably improve efficient arrangement of parts of the operating device while improving flexibility of controlling another device using the first electric switch, the second electric switch, and the third electric switch.

In accordance with a ninth aspect of the present invention, the operating device according to any one of the third to eighth aspects is configured so that the first pivot axis is spaced apart from the second pivot axis as viewed in a first direction perpendicular to the first surface.

With the operating device according to the ninth aspect, it is possible to reliably improve efficient arrangement of parts of the operating device while improving flexibility of controlling another device using the first electric switch, the second electric switch, and the third electric switch.

In accordance with a tenth aspect of the present invention, the operating device according to any one of the first to ninth aspects is configured so that a first minimum distance is defined between the first electric switch and the third electric switch. A second minimum distance is defined between the second electric switch and the third electric switch. The first minimum distance is different from the second minimum distance.

With the operating device according to the tenth aspect, it is possible to reliably improve efficient arrangement of parts of the operating device while improving flexibility of controlling another device using the first electric switch, the second electric switch, and the third electric switch.

In accordance with an eleventh aspect of the present invention, an operating device of a human-powered vehicle comprises a base structure, a circuit board, a first operating member, a second operating member, a third operating member, a first electric switch, a second electric switch, and a third electric switch. The base structure is mountable to the human-powered vehicle. The circuit board includes a first surface and a second surface provided on a reverse side of the first surface. The first operating member is movably coupled to the base structure. The second operating member is movably coupled to the base structure. The third operating member is movably coupled to the base structure. The first electric switch is configured to be activated in response to a movement of the first operating member. The second electric switch is configured to be activated in response to a movement of the second operating member. The third electric switch is configured to be activated in response to a movement of the third operating member. A first minimum distance is defined between the first electric switch and the third electric switch. A second minimum distance is defined between the second electric switch and the third electric switch. The first minimum distance is different from the second minimum distance.

With the operating device according to the eleventh aspect, it is possible to improve efficient arrangement of parts of the operating device while improving flexibility of controlling another device using the first electric switch, the second electric switch, and the third electric switch.

In accordance with a twelfth aspect of the present invention, the operating device according to the tenth or eleventh aspect is configured so that the first minimum distance is shorter than the second minimum distance.

With the operating device according to the twelfth aspect, it is possible to reliably improve efficient arrangement of parts of the operating device while improving flexibility of controlling another device using the first electric switch, the second electric switch, and the third electric switch.

In accordance with a thirteenth aspect of the present invention, the operating device according to any one of the first to twelfth aspects further comprises a circuit board support. The circuit board is fastened to the circuit board support. The circuit board support is a separate member from the base structure.

With the operating device according to the thirteenth aspect, the circuit board support can stabilize the position of the circuit board relative to the base structure with a comparatively simple structure.

In accordance with a fourteenth aspect of the present invention, the operating device according to the thirteenth aspect is configured so that the circuit board support at least partially overlaps the circuit board as viewed in a first direction perpendicular to the first surface.

With the operating device according to the fourteenth aspect, the circuit board support can reliably stabilize the position of the circuit board relative to the base structure with a comparatively simple structure.

In accordance with a fifteenth aspect of the present invention, the operating device according to the thirteenth or fourteenth aspect is configured so that the circuit board support is fastened to the second surface of the circuit board.

With the operating device according to the fifteenth aspect, the circuit board support can reliably stabilize the position of the circuit board relative to the base structure with a comparatively simple structure.

In accordance with a sixteenth aspect of the present invention, the operating device according to any one of the thirteenth to fifteenth aspects further comprises a support fastener configured to fasten the circuit board to the circuit board support.

With the operating device according to the sixteenth aspect, the circuit board support and the support fastener can reliably stabilize the position of the circuit board relative to the base structure with a comparatively simple structure.

In accordance with a seventeenth aspect of the present invention, the operating device according to the sixteenth aspect is configured so that the circuit board support includes a support fastener hole. The support fastener is at least partially provided in the support fastener hole.

With the operating device according to the seventeenth aspect, the circuit board support, the support fastener, and the support fastener hole can reliably stabilize the position of the circuit board relative to the base structure with a comparatively simple structure.

In accordance with an eighteenth aspect of the present invention, the operating device according to the sixteenth or seventeenth aspect is configured so that the first operating member is pivotally coupled to the base structure about a first pivot axis. The second operating member is pivotally coupled to the base structure about a second pivot axis. The support fastener is at least partially provided between the first pivot axis and the second pivot axis as viewed in a first direction perpendicular to the first surface.

With the operating device according to the eighteenth aspect, it is possible to efficiently arrange the first operating member, the second operating member, and the support fastener.

In accordance with a nineteenth aspect of the present invention, the operating device according to any one of the thirteenth to eighteenth aspects further comprises a power source holder configured to hold an electric power source. The circuit board support is coupled to the power source holder.

With the operating device according to the nineteenth aspect, it is possible to stabilize the position of the circuit board support using the power source holder.

In accordance with a twentieth aspect of the present invention, the operating device according to the nineteenth aspect is configured so that the power source holder is coupled to the base structure.

With the operating device according to the twentieth aspect, it is possible to reliably stabilize the position of the circuit board support using the power source holder.

In accordance with a twenty-first aspect of the present invention, the operating device according to the nineteenth or twentieth aspect is configured so that the power source holder includes a holder body and a power source terminal. The holder body is made of a non-metallic material. The power source terminal is made of a metallic material. The circuit board support is coupled to the holder body.

With the operating device according to the twenty-first aspect, it is possible to reliably stabilize the position of the circuit board support using the holder body of the power source holder.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a perspective elevational view of an operating device in accordance with one of embodiments.

FIG. 2 is another perspective elevational view of the operating device illustrated in FIG. 1.

FIG. 3 is an exploded perspective view of the operating device illustrated in FIG. 1.

FIG. 4 is a cross-sectional view of the operating device taken along line IV-IV of FIG. 1.

FIG. 5 is a cross-sectional view of the operating device taken along line V-V of FIG. 1.

FIG. 6 is a cross-sectional view of the operating device taken along line VI-VI of FIG. 5.

FIG. 7 is a cross-sectional view of the operating device taken along line VII-VII of FIG. 5.

FIG. 8 is an exploded perspective view of the operating device illustrated in FIG. 1.

FIG. 9 is a perspective view of an electric power source of the operating device illustrated in FIG. 1.

FIG. 10 is a plan view of the operating device illustrated in FIG. 1, with a part of a base structure omitted.

FIG. 11 is a schematic block diagram of the operating device illustrated in FIG. 1.

### DESCRIPTION OF THE EMBODIMENTS

The embodiments will now be described with reference to the accompanying drawings, wherein like reference numerals designate corresponding or identical elements throughout the various drawings.

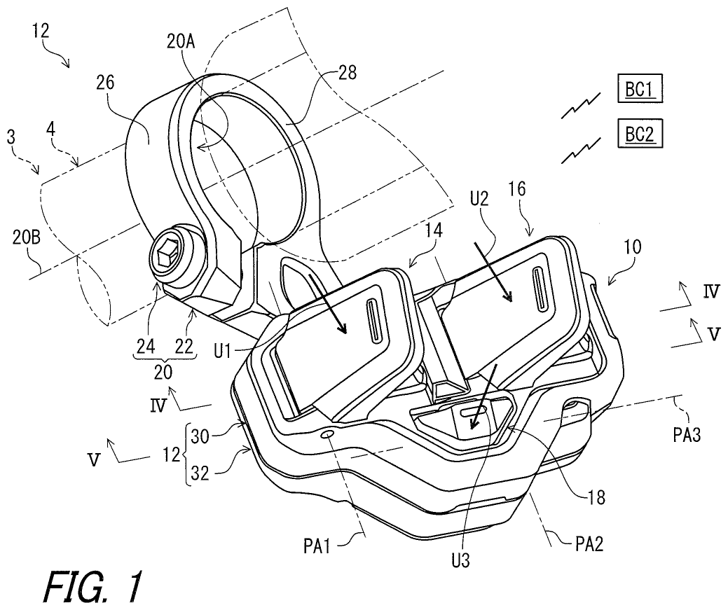

As seen in FIG. 1, an operating device 10 of a human-powered vehicle 2 is configured to operate at least one device. The operating device 10 is configured to be mounted to a vehicle body 3 of the human-powered vehicle 2. The operating device 10 is configured to be mounted to a handlebar 4 of the vehicle body 3 of the human-powered vehicle 2.

In the present application, the term “human-powered vehicle” includes a vehicle to travel with a motive power including at least a human power of a user who rides the vehicle. The human-powered vehicle includes a various kind of bicycles such as a mountain bike, a road bike, a city bike, a cargo bike, a hand bike, and a recumbent bike. Furthermore, the human-powered vehicle includes an electric bike called as an E-bike. The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only a driving source as motive power. Examples of the driving source include an internal-combustion engine and an electric motor. Generally, a light road vehicle, which includes a vehicle that does not require a driver's license for a public road, is assumed as the human-powered vehicle.

In the present application, the following directional terms “front,” “rear,” “forward,” “rearward,” “left,” “right,” “transverse,” “upward” and “downward” as well as any other similar directional terms refer to those directions which are determined based on the user who is in the user's standard position in the human-powered vehicle 2 while the user faces a handlebar or steering. Examples of the user's standard position include a saddle and a seat. Accordingly, these terms, as utilized to describe the operating device 10 or other devices, should be interpreted relative to the human-powered vehicle 2 equipped with the operating device 10 or other devices as used in an upright riding position on a horizontal surface.

The operating device 10 is configured to be electrically connected to an electric device BC1. In the present embodiment, the operating device 10 is configured to be connected to the electric device BC1 via a wireless communication channel. The operating device 10 is configured to be wirelessly connected to the electric device BC1. However, the operating device 10 can be configured to be connected to the electric device BC1 or other devices via an electric cable if needed or desired.

The operating device 10 is configured to be electrically connected to an electric device BC2. In the present embodiment, the operating device 10 is configured to be connected to the electric device BC2 via a wireless communication channel. The operating device 10 is configured to be wirelessly connected to the electric device BC2. However, the operating device 10 can be configured to be connected to the electric device BC2 or other devices via an electric cable if needed or desired.

Examples of the electric devices BC1 and BC2 include an additional or satellite operating device, an adjustable seatpost, a suspension, a gear changer, a brake device, a lighting device, an assist drive unit, a cycle computer, a smartphone, a tablet computer, and a personal computer. In the present embodiment, the electric device BC1 includes a gear changer such as a derailleur. The electric device BC2 includes a gear changer such as a derailleur. However, the electric devices BC1 and BC2 are not limited to the above devices.

In the present embodiment, the operating device 10 is a left-hand side operating device configured to be operated by the rider's left hand to actuate the electric devices BC1 and BC2 or other devices. However, the structures of the operating device 10 can be applied to a right-hand side operating device.

As seen in FIG. 1, the operating device 10 of the human-powered vehicle 2 comprises a base structure 12, a first operating member 14, a second operating member 16, and a third operating member 18. The base structure 12 is mountable to the human-powered vehicle 2. The base structure 12 is mountable to the vehicle body 3 of the human-powered vehicle 2. The base structure 12 is mountable to the handlebar 4 of the vehicle body 3. The first operating member 14 is configured to be provided closer to the rider than the second operating member 16 in a mounting state where the base structure 12 is mounted to the vehicle body 3.

The first operating member 14 is movably coupled to the base structure 12. The second operating member 16 is movably coupled to the base structure 12. The third operating member 18 is movably coupled to the base structure 12.

The first operating member 14 is configured to receive a first user input U1. The second operating member 16 is configured to receive a second user input U2. The third operating member 18 is configured to receive a third user input U3. The first operating member 14 is movable relative to the base structure 12 in response to the first user input U1. The second operating member 16 is movable relative to the base structure 12 in response to the second user input U2. The third operating member 18 is movable relative to the base structure 12 in response to the third user input U3.

In the present embodiment, the first operating member 14 is pivotally coupled to the base structure 12 about a first pivot axis PA1. The second operating member 16 is pivotally coupled to the base structure 12 about a second pivot axis PA2. The third operating member 18 is pivotally coupled to the base structure 12 about a third pivot axis PA3. However, the first operating member 14 can be configured to be movable relative to the base structure 12 without pivoting relative to the base structure 12 if needed or desired. The second operating member 16 can be configured to be movable relative to the base structure 12 without pivoting relative to the base structure 12 if needed or desired. The third operating member 18 can be configured to be movable relative to the base structure 12 without pivoting relative to the base structure 12 if needed or desired.

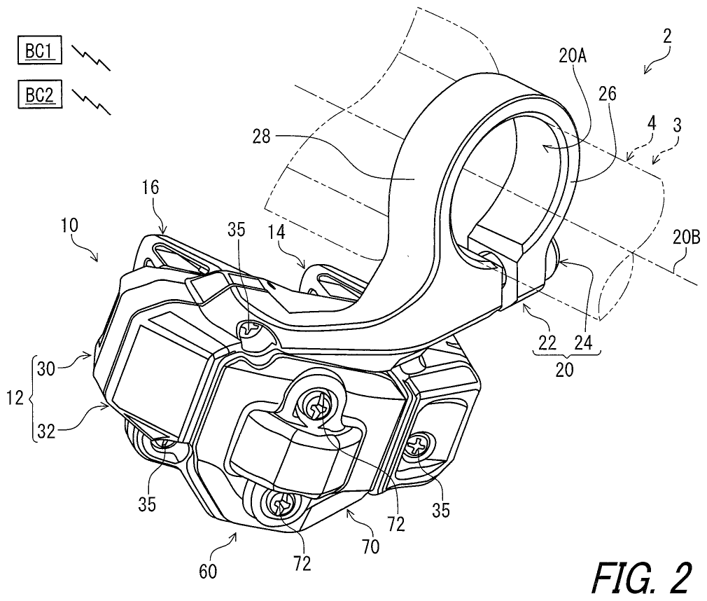

As seen in FIG. 2, the operating device 10 of the human-powered vehicle 2 comprises a clamp 20. The clamp 20 is configured to couple the base structure 12 to the vehicle body 3 of the human-powered vehicle 2. The clamp 20 includes a clamp opening 20A through which the handlebar 4 is to extend. The clamp opening 20A has a center axis 20B. The clamp 20 is at least partially made of a non-metallic material such as elastomer or resin. However, the clamp 20 can be at least partially made of a metallic material if needed or desired.

As seen in FIG. 2, the clamp 20 includes a clamp body 22 and a clamp fastener 24. The clamp body 22 includes a first clamp portion 26 and a second clamp portion 28. The first clamp portion 26 and the second clamp portion 28 define the clamp opening 20A. The clamp fastener 24 is configured to couple the first clamp portion 26 and the second clamp portion 28. At least one of the first clamp portion 26 and the second clamp portion 28 is deformable to change an inner diameter of the clamp opening 20A. The clamp fastener 24 is configured to couple the first clamp portion 26 and the second clamp portion 28 to change the inner diameter of the clamp opening 20A.

In the present embodiment, the second clamp portion 28 is integrally provided with the first clamp portion 26 as a one-piece unitary member. The clamp body 22 is made of a non-metallic material such as elastomer or resin. The first clamp portion 26 and the second clamp portion 28 are made of a non-metallic material such as elastomer or resin. However, the second clamp portion 28 can be a separate portion from the first clamp portion 26 if needed or desired. The clamp body 22 can be at least partially made of a metallic material if needed or desired. At least one of the first clamp portion 26 and the second clamp portion 28 can be at least partially made of a metallic material if needed or desired.

As seen in FIG. 2, the base structure 12 includes a first base 30 and a second base 32. The second base 32 is a separate member from the first base 30. The second base 32 is fastened to the first base 30 with fasteners 35. The clamp 20 is coupled to the second base 32. In the present embodiment, the clamp body 22 is provided integrally with the second base 32 as a one-piece unitary member. However, the clamp body 22 can be a separate member from the second base 32 if needed or desired.

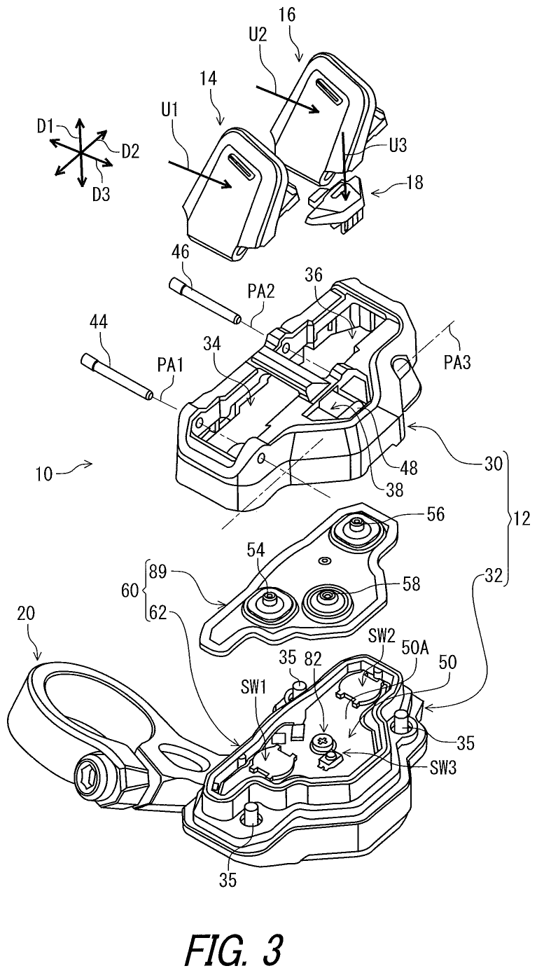

As seen in FIG. 3, the base structure 12 includes a first opening 34, a second opening 36, and a third opening 38. The first base 30 includes the first opening 34, the second opening 36, and the third opening 38.

The first operating member 14 is at least partially provided in the first opening 34. The first operating member 14 is movably provided in the first opening 34. The operating device 10 includes a first pivot pin 44. The first pivot pin 44 defines the first pivot axis PA1. The first operating member 14 is pivotally coupled to the base structure 12 via the first pivot pin 44.

The second operating member 16 is at least partially provided in the second opening 36. The second operating member 16 is movably provided in the second opening 36. The operating device 10 includes a second pivot pin 46. The second pivot pin 46 defines the second pivot axis PA2. The second operating member 16 is pivotally coupled to the base structure 12 via the second pivot pin 46.

The third operating member 18 is at least partially provided in the third opening 38. The third operating member 18 is movably provided in the third opening 38. The operating device 10 includes a third pivot pin 48. The third pivot pin 48 defines the third pivot axis PA3. The third operating member 18 is pivotally coupled to the base structure 12 via the third pivot pin 48.

As seen in FIG. 3, the operating device 10 of the human-powered vehicle 2 comprises a first electric switch SW1, a second electric switch SW2, and a third electric switch SW3. The first electric switch SW1 is configured to be activated in response to a movement of the first operating member 14. The second electric switch SW2 is configured to be activated in response to a movement of the second operating member 16. The third electric switch SW3 is configured to be activated in response to a movement of the third operating member 18.

The first electric switch SW1 is configured to be turned on in response to the movement of the first operating member 14. The second electric switch SW2 is configured to be turned on in response to the movement of the second operating member 16. The third electric switch SW3 is configured to be turned on in response to the movement of the third operating member 18.

The first electric switch SW1 is configured to be activated in response to the movement of the first operating member 14 caused by the first user input U1. The second electric switch SW2 is configured to be activated in response to the movement of the second operating member 16 caused by the second user input U2. The third electric switch SW3 is configured to be activated in response to the movement of the third operating member 18 caused by the third user input U3.

As seen in FIG. 3, the operating device 10 of the human-powered vehicle 2 comprises a circuit board 50. The first electric switch SW1, the second electric switch SW2, and the third electric switch SW3 are provided on the circuit board 50. The first electric switch SW1 is electrically mounted on the circuit board 50. The second electric switch SW2 is electrically mounted on the circuit board 50. The third electric switch SW3 is electrically mounted on the circuit board 50.

The circuit board 50 includes a first surface 50A. The first electric switch SW1, the second electric switch SW2, and the third electric switch SW3 are provided on the first surface 50A. The first surface 50A is arranged to face toward the first operating member 14, the second operating member 16, and the third operating member 18 in a first direction D1 perpendicular to the first surface 50A.

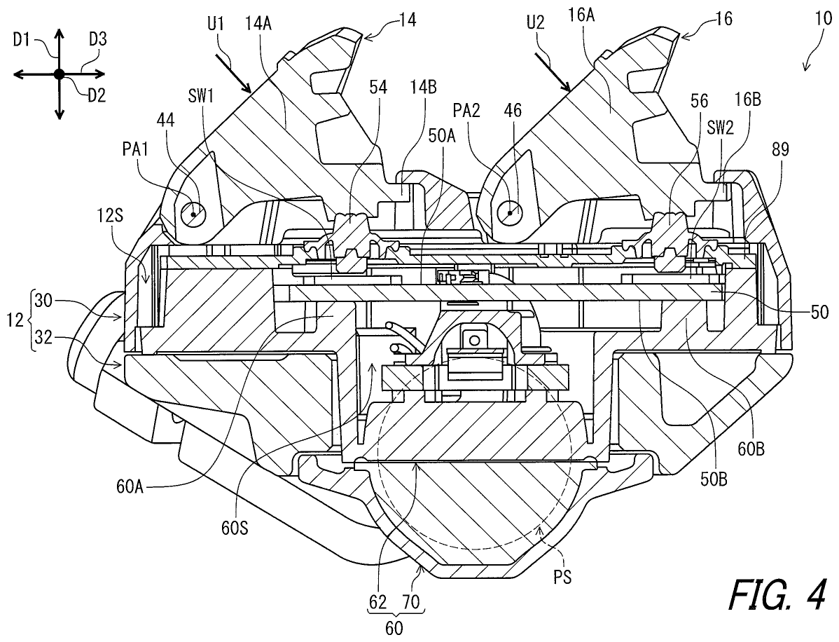

As seen in FIG. 4, the circuit board 50 includes a second surface 50B. The second surface 50B is provided on a reverse side of the first surface 50A. The second surface 50B is provided on a reverse side of the first surface 50A in the first surface 50A.

The first operating member 14 includes a first operating body 14A and a first stopper 14B. The first operating body 14A is pivotally coupled to the base structure 12 about the first pivot axis PA1. The first stopper 14B protrudes from the first operating body 14A away from the first pivot axis PA1. The first stopper 14B is contactable with the base structure 12 to position the first operating member 14 in a rest position.

The second operating member 16 includes a second operating body 16A and a second stopper 16B. The second operating body 16A is pivotally coupled to the base structure 12 about the second pivot axis PA2. The second stopper 16B protrudes from the second operating body 16A away from the second pivot axis PA2. The second stopper 16B is contactable with the base structure 12 to position the second operating member 16 in a rest position.

The operating device 10 includes a first button 54. The first button 54 is at least partially provided between the first operating member 14 and the first electric switch SW1 to transmit the movement of the first operating member 14 to the first electric switch SW1. The first button 54 is movable relative to the base structure 12.

The operating device 10 includes a second button 56. The second button 56 is at least partially provided between the second operating member 16 and the second electric switch SW2 to transmit the movement of the second operating member 16 to the second electric switch SW2. The second button 56 is movable relative to the base structure 12.

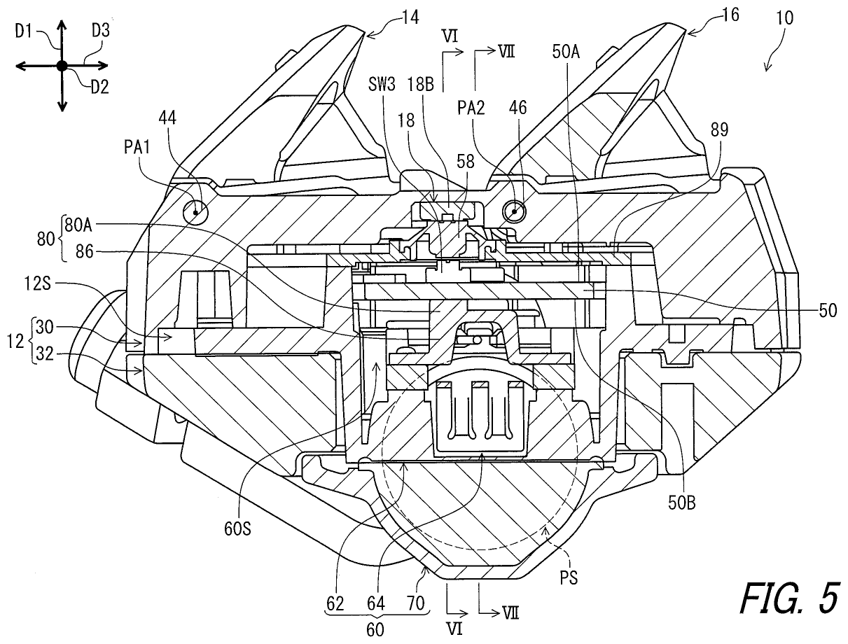

As seen in FIG. 5, the third operating member 18 includes a third operating body 18A and a third stopper 18B. The third operating body 18A is pivotally coupled to the base structure 12 about the third pivot axis PA3. The third stopper 18B protrudes from the third operating body 18A away from the third pivot axis PA3. The third stopper 18B is contactable with the base structure 12 to position the third operating member 18 in a rest position.

The operating device 10 includes a third button 58. The third button 58 is at least partially provided between the third operating member 18 and the third electric switch SW3 to transmit the movement of the third operating member 18 to the third electric switch SW3. The third button 58 is movable relative to the base structure 12.

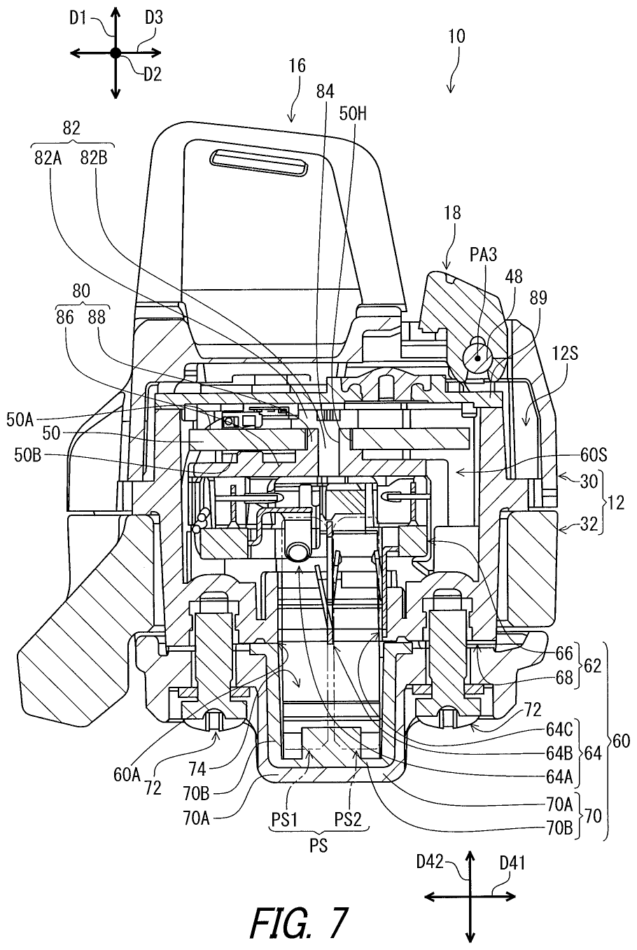

As seen in FIG. 7, the operating device 10 further comprises a power source holder 60. The power source holder 60 is configured to hold an electric power source PS. The power source holder 60 is coupled to the base structure 12. The power source holder 60 is a separate member from the base structure 12.

The base structure 12 includes an internal space 12S. The first base 30 and the second base 32 define the internal space 12S. The power source holder 60 is at least partially provided in the internal space 12S. The power source holder 60 is at least partially provided between the first base 30 and the second base 32. The power source holder 60 is held between the first base 30 and the second base 32.

The power source holder 60 includes a holder body 62 and a power source terminal 64. For example, the holder body 62 is made of a non-metallic material. The power source terminal 64 is made of a metallic material.

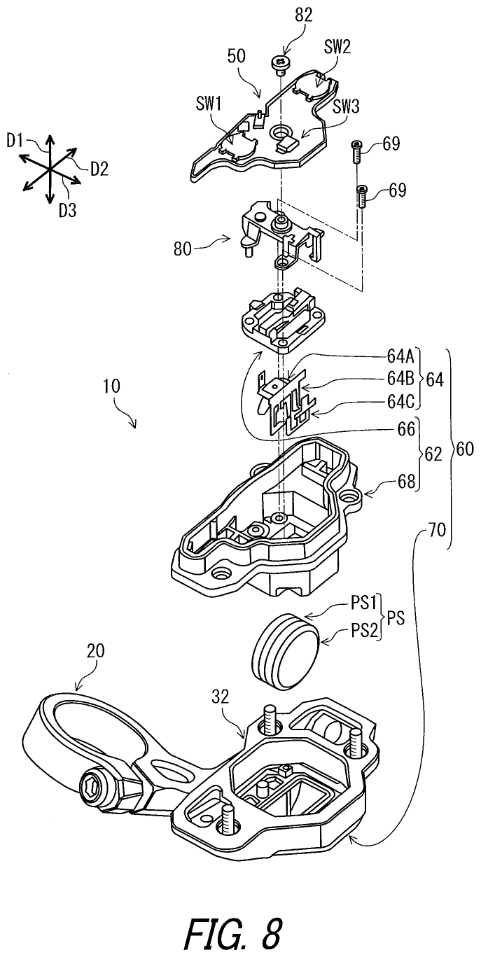

As seen in FIG. 8, the holder body 62 includes a first holder body 66 and a second holder body 68. The second holder body 68 is a separate member from the first holder body 66. The second holder body 68 is fastened to the first holder body 66 with holder fasteners 69. The power source terminal 64 is coupled to the first holder body 66.

The power source terminal 64 includes a first terminal 64A, a second terminal 64B, and a third terminal 64C. The first terminal 64A is made of a metallic material. The second terminal 64B is made of a metallic material. The second terminal 64B is made of a metallic material. The first terminal 64A is coupled to the first holder body 66. The second terminal 64B is coupled to the first holder body 66. The third terminal 64C is coupled to the first holder body 66. The third terminal 64C is at least partially provided between the first terminal 64A and the second terminal 64B.

In the present embodiment, the electric power source PS includes a first electric power source PS1 and a second electric power source PS2. The second electric power source PS2 is a separate electric power source from the first electric power source PS1.

Examples of the electric power source PS include a primary battery and a secondary battery. Examples of the first electric power source PS1 include a primary battery and a secondary battery. Examples of the second electric power source PS2 include a primary battery and a secondary battery. The first electric power source PS1 includes a coin battery. The second electric power source PS2 includes a coin battery. However, the first electric power source PS1 can include a battery other than the coin battery if needed or desired. The second electric power source PS2 can include a battery other than the coin battery if needed or desired.

As seen in FIG. 7, the first terminal 64A is in contact with one of a positive terminal and a negative terminal of the first electric power source PS1 in a state where the power source holder 60 holds the electric power source PS. The third terminal 64C is in contact with the other of the positive terminal and the negative terminal of the first electric power source PS1 in the state where the power source holder 60 holds the electric power source PS. The second terminal 64B is in contact with one of a positive terminal and a negative terminal of the second electric power source PS2 in the state where the power source holder 60 holds the electric power source PS. The third terminal 64C is in contact with the other of the positive terminal and the negative terminal of the second electric power source PS2 in the state where the power source holder 60 holds the electric power source PS.

The power source holder 60 includes a lid 70. The lid 70 is detachably and reattachably coupled to the holder body 62. The lid 70 is detachably and reattachably fastened to the base structure 12 with lid fasteners 72.

The lid 70 includes a recess 74 in which the electric power source PS is at least partially provided in a state where the lid 70 is fastened to the base structure 12 and where the power source holder 60 holds the electric power source PS. The first electric power source PS1 is at least partially provided in the recess 74 in the state where the lid 70 is fastened to the base structure 12 and where the power source holder 60 holds the electric power source PS. The second electric power source PS2 is at least partially provided in the recess 74 in the state where the lid 70 is fastened to the base structure 12 and where the power source holder 60 holds the electric power source PS.

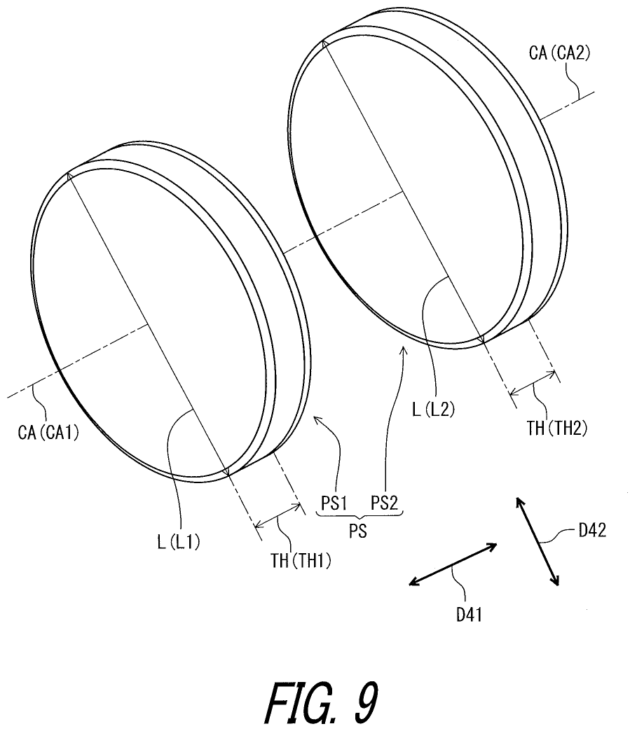

As seen in FIG. 9, the electric power source PS has a thickness TH defined in a first size direction D41. The first electric power source PS1 has a first thickness TH1 defined in the first size direction D41. The second electric power source PS2 has a second thickness TH2 defined in the first size direction D41. The first electric power source PS1 and the second electric power source PS2 are arranged in the first size direction D41.

The electric power source PS has a center axis CA. The first electric power source PS1 has a first center axis CA1. The second electric power source PS2 has a second center axis CA2. The first size direction D41 is defined along the center axis. The first size direction D41 is defined along the first center axis CA1. The first size direction D41 is defined along the second center axis CA2.

The electric power source PS has an outer length L defined in a second size direction D42 perpendicular to the first size direction D41. The first electric power source PS1 has a first outer length L1 defined in the second size direction D42. The second electric power source PS2 has a second outer length L2. The first electric power source PS1 has a disc shape. The second electric power source PS2 has a disc shape. Thus, the first outer length L1 can also be referred to as a first outer diameter L1. The second outer length L2 can also be referred to as a second outer diameter L1. The shape of the first electric power source PS1 is not limited to the disc shape. The shape of the second electric power source PS2 is not limited to the disc shape.

The outer length L of the electric power source PS is longer than the thickness TH of the electric power source PS. The first outer length L1 of the first electric power source PS1 is longer than the first thickness TH1 of the first electric power source PS1. The second outer length L2 of the second electric power source PS2 is longer than the second thickness TH2 of the second electric power source PS2.

In the present embodiment, the first size direction D41 is parallel to the third direction D3 in the state where the power source holder 60 holds the electric power source PS. The second size direction D42 is parallel to the first direction D1 in the state where the power source holder 60 holds the electric power source PS. However, the first size direction D41 can be non-parallel to the third direction D3 in the state where the power source holder 60 holds the electric power source PS if needed or desired. The second size direction D42 can be non-parallel to the first direction D1 in the state where the power source holder 60 holds the electric power source PS if needed or desired.

As seen in FIG. 7, the power source holder 60 includes an insertion opening 60A. The insertion opening 60A is open to the outside of the operating device 10 in a detachment state where the lid 70 is detached from the base structure 12. The lid 70 is configured to cover the insertion opening 60A in an attachment state where the lid 70 is fastened to the base structure 12.

The electric power source PS is configured to be inserted into the insertion opening 60A along the second size direction D42 perpendicular to the first size direction D41 in the detachment state. The first electric power source PS1 is configured to be inserted into the insertion opening 60A in the second size direction D42 in the detachment state. The second electric power source PS2 is configured to be inserted into the insertion opening 60A in the second size direction D42 in the detachment state.

As seen in FIG. 8, the operating device 10 further comprises a circuit board support 80. The circuit board support 80 is coupled to the power source holder 60. The circuit board support 80 is coupled to the holder body 62. The circuit board support 80 is coupled to the first holder body 66. The circuit board support 80 is fastened to the power source holder 60 with the holder fasteners 69. The circuit board support 80 is fastened to the holder body 62 with the holder fasteners 69. The circuit board support 80 is fastened to the first holder body 66 with the holder fasteners 69. The circuit board support 80 can be fastened to the power source holder 60 with a fastener other than the holder fasteners 69 if needed or desired.

The circuit board 50 is fastened to the circuit board support 80. The circuit board support 80 is a separate member from the base structure 12. The circuit board support 80 is fastened to the second surface 50B of the circuit board 50. The circuit board support 80 is in contact with the second surface 50B. The operating device 10 further comprises a support fastener 82. The support fastener 82 is configured to fasten the circuit board 50 to the circuit board support 80.

As seen in FIG. 7, the circuit board support 80 includes a support fastener hole 84. The support fastener 82 is at least partially provided in the support fastener hole 84. The circuit board 50 includes a hole 50H. The support fastener 82 is at least partially provided in the hole 50H.

The support fastener hole 84 includes a threaded hole. The support fastener 82 includes an externally threaded portion 82A and a head portion 82B. The externally threaded portion 82A extends from the head portion 82B. The head portion 82B has an outer diameter greater than an outer diameter of the externally threaded portion 82A. The externally threaded portion 82A is configured to be threadedly engaged with the support fastener hole 84.

The circuit board support 80 is at least partially provided in the hole 50H. In the present embodiment, the circuit board support 80 includes a support body 86 and a protrusion 88. The support body 86 is fastened to the power source holder 60. The protrusion 88 protrudes from the support body 86. The support body 86 and the protrusion 88 includes the support fastener hole 84. The protrusion 88 is at least partially provided in the hole 50H to position the circuit board 50 relative to the circuit board support 80. The circuit board 50 is at least partially provided between the head portion 82B of the support fastener 82 and the support body 86 of the circuit board support 80.

As seen in FIG. 4, the circuit board 50 is contactable with the power source holder 60. The circuit board 50 is contactable with the holder body 62. The circuit board 50 is contactable with the first holder body 66. The second surface 50B of the circuit board 50 is contactable with the first holder body 66.

The holder body 62 includes a first support portion 66A. The first holder body 66 includes the first support portion 66A. The first support portion 66A is contactable with the second surface 50B of the circuit board 50. The first support portion 66A is provided on an opposite side of the first electric switch SW1 with respect to the circuit board 50 to receive force applied to the first electric switch SW1.

The holder body 62 includes a second support portion 66B. The second holder body 68 includes the second support portion 66B. The second support portion 66B is in contact with the second surface 50B of the circuit board 50. The second support portion 66B is provided on an opposite side of the second electric switch SW2 with respect to the circuit board 50 to receive force applied to the second electric switch SW2.

As seen in FIG. 5, the circuit board support 80 includes a third support portion 80A. The third support portion 80A is contactable with the second surface 50B of the circuit board 50. The third support portion 80A is provided on an opposite side of the third electric switch SW3 with respect to the circuit board 50 to receive force applied to the third electric switch SW3.

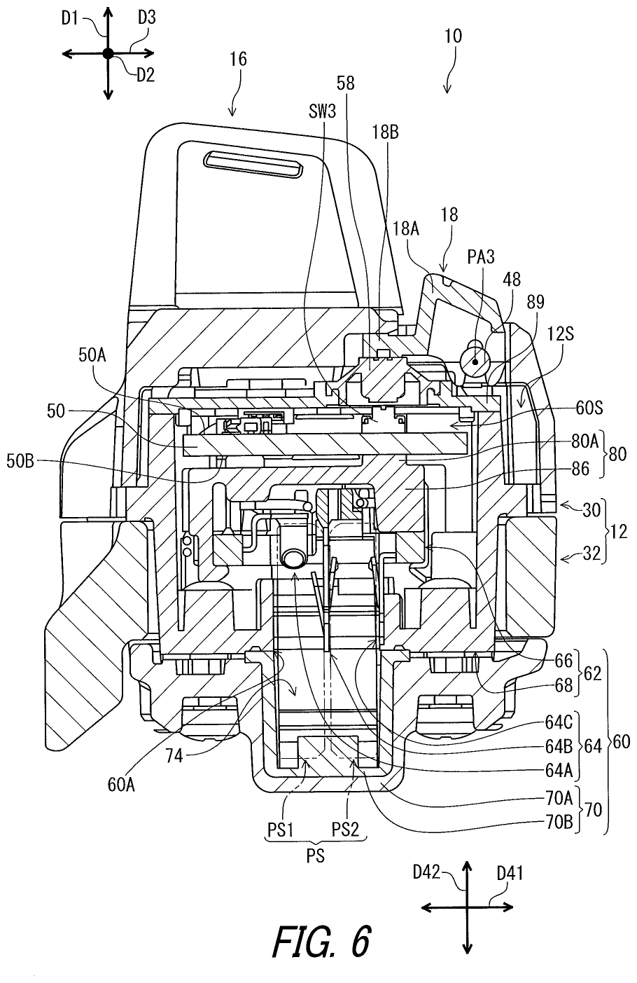

As seen in FIG. 4, the power source holder 60 includes a cover 89. The cover 89 is attached to the holder body 62. The cover 89 is provided to face the circuit board 50 in the first direction D1. For example, the cover 89 is attached to the second holder body 68 with adhesive to seal a gap between the cover 89 and the second holder body 68. The first button 54 is movably coupled to the cover 89. The second button 56 is movably coupled to the cover 89. As seen in FIG. 6, the third button 58 is movably coupled to the cover 89.

The lid 70 includes a lid body 70A and a seal member 70B. The lid body 70A is configured to be fastened to the holder body 62. The seal member 70B is attached to the lid body 70A to seal a gap between the lid body 70A and the holder body 62 in a state where the lid 70 is fastened to the holder body 62. The power source holder 60 includes an inertial holder space 60S in which the circuit board 50, the circuit board support 80, and the electric power source PS are provided. The internal holder space 60S is sealed by the holder body 62, the lid 70, and the cover 89.

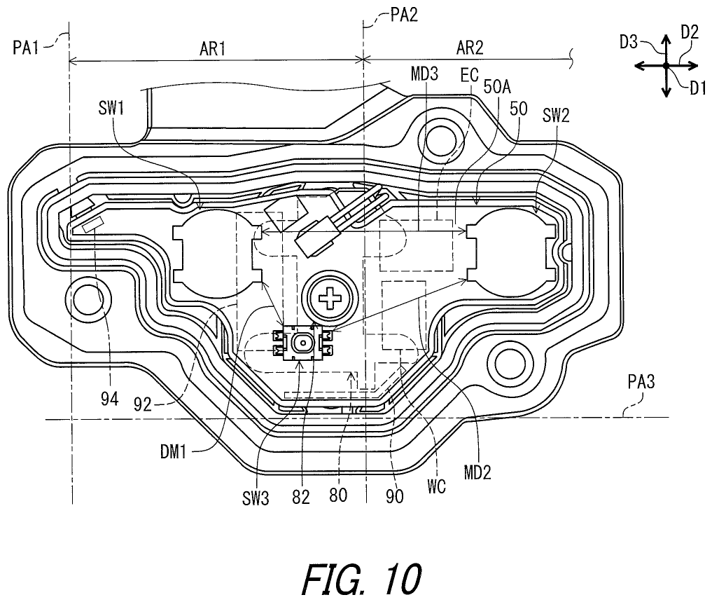

As seen in FIG. 10, the first pivot axis PA1 is spaced apart from the second pivot axis PA2 as viewed in the first direction D1 perpendicular to the first surface 50A. The first pivot axis PA1 is spaced apart from the second pivot axis PA2 in a second direction D2 perpendicular to the first direction D1. The first pivot axis PA1 extends in a third direction D3. The second pivot axis PA2 extends in the third direction D3. The third direction D3 is perpendicular to each of the first direction D1 and the second direction D2.

As seen in FIG. 5, the circuit board 50 extends in the second direction D2. The first surface 50A extends in the second direction D2. The second surface 50B extends in the second direction D2.

As seen in FIG. 7, the circuit board 50 extends in the third direction D3. The first surface 50A extends in the third direction D3. The second surface 50B extends in the third direction D3.

As seen in FIG. 10, the circuit board support 80 at least partially overlaps the circuit board 50 as viewed in the first direction D1 perpendicular to the first surface 50A. In the present embodiment, the circuit board support 80 partially overlaps the circuit board 50 as viewed in the first direction D1. However, the circuit board support 80 can be arranged to entirely overlap the circuit board 50 as viewed in the first direction D1 if needed or desired.

The second pivot axis PA2 is provided between the first electric switch SW1 and the second electric switch SW2 as viewed in the first direction D1 perpendicular to the first surface 50A. The second pivot axis PA2 is provided between the second electric switch SW2 and the third electric switch SW3 as viewed in the first direction D1 perpendicular to the first surface 50A. The second pivot axis PA2 is provided between the first electric switch SW1 and the second electric switch SW2 in the second direction D2 as viewed in the first direction D1. The second pivot axis PA2 is provided between the second electric switch SW2 and the third electric switch SW3 in the second direction D2 as viewed in the first direction D1. The positional relationship between the second pivot axis PA2, the first electric switch SW1, and the second electric switch SW2 is not limited to the illustrated embodiment. The positional relationship between the second pivot axis PA2, the second electric switch SW2, and the third electric switch SW3 is not limited to the illustrated embodiment.

As seen in FIG. 10, the first electric switch SW1 is at least partially provided between the first pivot axis PA1 and the second pivot axis PA2 as viewed in the first direction D1 perpendicular to the first surface 50A. The third electric switch SW3 is at least partially provided between the first pivot axis PA1 and the second pivot axis PA2 as viewed in the first direction D1 perpendicular to the first surface 50A. The first electric switch SW1 is at least partially provided between the first pivot axis PA1 and the second pivot axis PA2 in the second direction D2 as viewed in the first direction D1. The third electric switch SW3 is at least partially provided between the first pivot axis PA1 and the second pivot axis PA2 in the second direction D2 as viewed in the first direction D1.

In the present embodiment, the first electric switch SW1 is entirely provided between the first pivot axis PA1 and the second pivot axis PA2 as viewed in the first direction D1. The third electric switch SW3 is entirely provided between the first pivot axis PA1 and the second pivot axis PA2 as viewed in the first direction D1. The first electric switch SW1 is entirely provided between the first pivot axis PA1 and the second pivot axis PA2 in the second direction D2 as viewed in the first direction D1. The third electric switch SW3 is entirely provided between the first pivot axis PA1 and the second pivot axis PA2 in the second direction D2 as viewed in the first direction D1.

However, the first electric switch SW1 can be partially provided between the first pivot axis PA1 and the second pivot axis PA2 as viewed in the first direction D1 if needed or desired. The third electric switch SW3 can be partially provided between the first pivot axis PA1 and the second pivot axis PA2 as viewed in the first direction D1 if needed or desired. The first electric switch SW1 can be partially provided between the first pivot axis PA1 and the second pivot axis PA2 in the second direction D2 as viewed in the first direction D1 if needed or desired. The third electric switch SW3 can be partially provided between the first pivot axis PA1 and the second pivot axis PA2 in the second direction D2 as viewed in the first direction D1 if needed or desired.

A first area AR1 is defined between the first pivot axis PA1 and the second pivot axis PA2 in the second direction D2 as viewed in the first direction D1. A second area AR2 is defined on an opposite side of the first area AR1 with respect to the second pivot axis PA2 in the second direction D2 as viewed in the first direction D1. The second pivot axis PA2 is provided between the first area AR1 and the second area AR2 in the second direction D2.

The first electric switch SW1 is at least partially provided in the first area AR1 as viewed in the first direction D1. The third electric switch SW3 is at least partially provided in the first area AR1 as viewed in the first direction D1. In the present embodiment, the first electric switch SW1 is entirely provided in the first area AR1 as viewed in the first direction D1. The third electric switch SW3 is entirely provided in the first area AR1 as viewed in the first direction D1. However, the first electric switch SW1 can be partially provided in the first area AR1 as viewed in the first direction D1 if needed or desired. The third electric switch SW3 can be partially provided in the first area AR1 as viewed in the first direction D1 if needed or desired.

The second electric switch SW2 is at least partially provided in the second area AR2 as viewed in the first direction D1. In the present embodiment, the second electric switch SW2 is entirely provided in the second area AR2 as viewed in the first direction D1. However, the second electric switch SW2 can be partially provided in the second area AR2 as viewed in the first direction D1 if needed or desired.

As seen in FIG. 10, the support fastener 82 is at least partially provided between the first pivot axis PA1 and the second pivot axis PA2 as viewed in the first direction D1 perpendicular to the first surface 50A. The support fastener 82 is at least partially provided between the first pivot axis PA1 and the second pivot axis PA2 in the second direction D2 as viewed in the first direction D1. The support fastener 82 is at least partially provided in the first area AR1 as viewed in the first direction D1.

In the present embodiment, the support fastener 82 is entirely provided between the first pivot axis PA1 and the second pivot axis PA2 as viewed in the first direction D1. The support fastener 82 is entirely provided between the first pivot axis PA1 and the second pivot axis PA2 in the second direction D2 as viewed in the first direction D1. The support fastener 82 is entirely provided in the first area AR1 as viewed in the first direction D1. The support fastener 82 is entirely provided between the first electric switch SW1 and the second electric switch SW2 in the second direction D2 as viewed in the first direction D1.

However, the support fastener 82 can be partially provided between the first pivot axis PA1 and the second pivot axis PA2 as viewed in the first direction D1 if needed or desired. The support fastener 82 can be partially provided between the first pivot axis PA1 and the second pivot axis PA2 in the second direction D2 as viewed in the first direction D1 if needed or desired. The support fastener 82 can be partially provided in the first area AR1 as viewed in the first direction D1 if needed or desired. The support fastener 82 can be partially provided between the first electric switch SW1 and the second electric switch SW2 in the second direction D2 as viewed in the first direction D1.

As seen in FIG. 10, a first minimum distance MD1 is defined between the first electric switch SW1 and the third electric switch SW3. A second minimum distance MD2 is defined between the second electric switch SW2 and the third electric switch SW3. A third minimum distance MD3 is defined between the first electric switch SW1 and the second electric switch SW2. The first minimum distance MD1 is different from the second minimum distance MD2. The first minimum distance MD1 is different from the third minimum distance MD3. The second minimum distance MD2 is different from the third minimum distance MD3.

In the present embodiment, the first minimum distance MD1 is shorter than the second minimum distance MD2. The first minimum distance MD1 is shorter than the third minimum distance MD3. The second minimum distance MD2 is shorter than the third minimum distance MD3.

However, the first minimum distance MD1 can be equal to or longer than the second minimum distance MD2 if needed or desired. The first minimum distance MD1 can be equal to or longer than the third minimum distance MD3 if needed or desired. The second minimum distance MD2 can be equal to or longer than the third minimum distance MD3 if needed or desired.

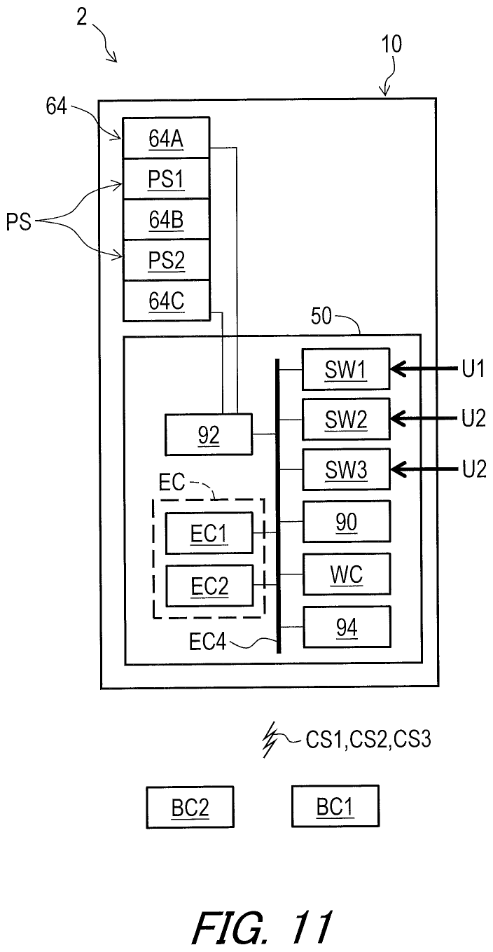

As seen in FIG. 11, the operating device 10 includes electronic controller circuitry EC, wireless communicator circuitry WC, antenna circuitry 90, power controller circuitry 92, and informing circuitry 94. The electronic controller circuitry EC is electrically connected to the wireless communicator circuitry WC, the antenna circuitry 90, the power controller circuitry 92, and the informing circuitry 94. The electronic controller circuitry EC is configured to control the wireless communicator circuitry WC, the antenna circuitry 90, the power controller circuitry 92, and the informing circuitry 94. The wireless communicator circuitry WC is electrically connected to the antenna circuitry AT. The wireless communicator circuitry WC is configured to wirelessly transmit signals via the antenna circuitry AT. The power controller circuitry 92 is electrically connected to the power source terminal 64 of the power source holder 60. The power controller circuitry 92 is configured to control electricity supplied from the electric power source PS.

The informing circuitry 94 is configured to inform the user of information relating to the human-powered vehicle 2. The informing circuitry 94 is configured to inform the user of information relating to the operating device 10. For example, the information relating to the human-powered vehicle 2 includes at least one of a state of the operating device 10, a state of the electric device BC1, and a state of the electric device BC2. For example, the information relating to the operating device 10 includes at least one of a state of the electronic controller circuitry EC, a state of the electric power source PS, and a state of the wireless communicator circuitry WC. The informing circuitry 94 includes an indicator configured to indicate information relating to the human-powered vehicle 2. Examples of the indicator include a light emitter. Examples of the light emitter include a light emitting diode (LED).

As seen in FIG. 11, the electronic controller circuitry EC includes a processor EC1 and a memory EC2. The operating device 10 includes a system bus EC4. The processor EC1 is coupled to the memory EC2. The memory EC2 is coupled to the processor EC1. The processor EC1 and the memory EC2 are electrically mounted on the circuit board 50. The processor EC1 is electrically connected to the memory EC2 via the circuit board 50 and the system bus EC4. The memory EC2 is electrically connected to the processor EC1 via the circuit board 50 and the system bus EC4. For example, the electronic controller circuitry EC includes a semiconductor. The processor EC1 includes a semiconductor. The memory EC2 includes a semiconductor. However, the electronic controller circuitry EC can be free of a semiconductor if needed or desired. The processor EC1 can be free of a semiconductor if needed or desired. The memory EC2 can be free of a semiconductor if needed or desired.

For example, the processor EC1 includes at least one of a central processing unit (CPU), a micro processing unit (MPU), and a memory controller. The memory EC2 is electrically connected to the processor EC1. For example, the memory EC2 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC2 includes storage areas each having an address. The processor EC1 is configured to control the memory EC2 to store data in the storage areas of the memory EC2 and reads data from the storage areas of the memory EC2. The processor EC1 can also be referred to as a hardware processor EC1 or a processor circuit or circuitry EC1. The memory EC2 can also be referred to as a hardware memory EC2 or a memory circuit or circuitry EC2. The memory EC2 can also be referred to as a non-transitory computer-readable storage medium EC2. Namely, the electronic controller circuitry EC includes the non-transitory computer-readable storage medium EC2.

The electronic controller circuitry EC is configured to execute at least one control algorithm of the operating device 10. For example, the electronic controller circuitry EC is programed to execute at least one control algorithm of the operating device 10. The memory EC2 stores at least one program including at least one program instruction. The at least one program is read into the processor EC1, and thereby the at least one control algorithm of the operating device 10 is executed based on the at least one program.

The structure of the electronic controller circuitry EC is not limited to the above structure. The structure of the electronic controller circuitry EC is not limited to the processor EC1 and the memory EC2. The electronic controller circuitry EC can be realized by hardware alone or a combination of hardware and software. In the present embodiment, the processor EC1 and the memory EC2 are integrated as a single chip such as an application specific integrated circuit (ASIC) or a field programmable gate array (FPGA). However, the processor EC1 and the memory EC2 can be separate chips if needed or desired. The electronic controller circuitry EC can include the processor EC1, the memory EC2, the circuit board 50, and the system bus EC4 if needed or desired. The electronic controller circuitry EC can be at least two electronic controllers which are separately provided.

The electronic controller circuitry EC can include at least two electronic controllers which are separately provided. The at least one control algorithm of the operating device 10 can be executed by the at least two electronic controllers if needed or desired. The electronic controller circuitry EC can include at least two hardware processors which are separately provided. The electronic controller circuitry EC can include at least two hardware memories which are separately provided. The at least one control algorithm of the operating device 10 can be executed by the at least two hardware processors if needed or desired. The at least one control algorithm of the operating device 10 can be stored in the at least two hardware memories if needed or desired. The electronic controller circuitry EC can include at least two circuit boards which are separately provided if needed or desired. The electronic controller circuitry EC can include at least two system buses which are separately provided if needed or desired.

As seen in FIG. 11, the wireless communicator circuitry WC is configured to wirelessly transmit a first signal CS1 in response to activation of the first electric switch SW1. For example, the electronic controller circuitry EC is configured to recognize the activation of the first electric switch SW1 in a case where the first electric switch SW1 receives the first user input U1. The electronic controller circuitry EC is configured to control the wireless communicator circuitry WC to wirelessly transmit the first signal CS1 in a case where the electronic controller circuitry EC recognizes the activation of the first electric switch SW1.

The wireless communicator circuitry WC is configured to wirelessly transmit a second signal CS2 in response to activation of the second electric switch SW2. For example, the electronic controller circuitry EC is configured to recognize the activation of the second electric switch SW2 in a case where the second electric switch SW2 receives the second user input U2. The electronic controller circuitry EC is configured to control the wireless communicator circuitry WC to wirelessly transmit the second signal CS2 in a case where the electronic controller circuitry EC recognizes the activation of the second electric switch SW2.

The wireless communicator circuitry WC is configured to wirelessly transmit a third signal CS3 in response to activation of the third electric switch SW3. For example, the electronic controller circuitry EC is configured to recognize the activation of the third electric switch SW3 in a case where the third electric switch SW3 receives the third user input U3. The electronic controller circuitry EC is configured to control the wireless communicator circuitry WC to wirelessly transmit the third signal CS3 in a case where the electronic controller circuitry EC recognizes the activation of the third electric switch SW3.

The term “wireless communicator” or “wireless communicator circuitry” as used herein includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. Here, the wireless communicator circuitry WC is configured to at least receive a wireless signal. For example, the wireless communicator circuitry WC includes a two-way wireless transceiver that conducts two-way wireless communications using the wireless receiver for wirelessly receiving signals and a wireless transmitter for wirelessly transmitting signals.

In the present embodiment, the wireless communicator circuitry WC can use radio frequency (RF) signals, ultra-wide band communication signals, radio frequency identification (RFID), Wi-Fi (registered trademark), Zigbee (registered trademark), ANT+ (registered trademark), or Bluetooth (registered trademark) or any other type of communication protocols suitable for short range wireless communications as understood in the human-powered vehicle field.

It should also be understood that the wireless communicator circuitry WC can transmit the signals at a particular or randomly selected frequency and/or with an identifier such as a particular code, to distinguish the wireless signal from other wireless signals. In this way, each of the operating device 10, the electric device BC1, and the electric device BC2 can recognize which signals are to be acted upon and which signals are not to be acted upon. Thus, each of the operating device 10, the electric device BC1, and the electric device BC2 can ignore the signals from other wireless communicators of other electric devices.

As seen in FIG. 11, the wireless communicator circuitry WC includes a signal transmitting circuit or circuitry, a signal receiving circuit or circuitry, and an antenna. The wireless communicator circuitry WC is configured to superimpose digital signals on carrier wave using the first communication protocol to wirelessly transmit signals. In the present embodiment, the wireless communicator circuitry WC is configured to encrypt signals using a cryptographic key to generate encrypted wireless signals. The wireless communicator circuitry WC is configured to transmit wireless signals via the antenna.

The wireless communicator circuitry WC is configured to receive wireless signals via the antenna. In the present embodiment, the wireless communicator circuitry WC is configured to decode the wireless signals to recognize signals transmitted from other wireless communicators. The wireless communicator circuitry WC is configured to decrypt the wireless signals using the cryptographic key.

In a case where the electric device BC1 includes a gear changer, for example, the first signal CS1 indicates one of upshifting and downshifting of the electric device BC1. The second signal CS2 indicates the other of upshifting and downshifting of the electric device BC1. In a case where the electric device BC2 includes a rider-posture changer such as an adjustable seatpost or a suspension, the third signal CS3 indicates changing of a state of the rider-posture changer. The electric device BC1 is not limited to the gear changer. The electric device BC2 is not limited to the rider-posture changer. Each of the electric devices BC1 and BC2 can include an adjustable seatpost, a suspension, a gear changer, a brake device, a lighting device, an assist drive unit, a cycle computer, a smartphone, a tablet computer, a personal computer, or other types of device if needed or desired.

As seen in FIG. 11, the electronic controller circuitry EC, the wireless communicator circuitry WC, the antenna circuitry 90, the power controller circuitry 92, and the informing circuitry 94 are provided on the second surface 50B of the circuit board 50. At least one of the electronic controller circuitry EC, the wireless communicator circuitry WC, the antenna circuitry 90, the power controller circuitry 92, and the informing circuitry 94 can be provided on the first surface 50A of the circuit board 50 if needed or desired.

FIG. 10 shows the arrangement of the electronic controller circuitry EC, the wireless communicator circuitry WC, the antenna circuitry 90, the power controller circuitry 92, and the informing circuitry 94. The electronic controller circuitry EC is entirely provided in the second area AR2. The wireless communicator circuitry WC is entirely provided in the second area AR2. The antenna circuitry 90 is provided in both the first area AR1 and the second area AR2. The power controller circuitry 92 is entirely provided in the first area AR1. The informing circuitry 94 is entirely provided in the first area AR1. However, the arrangement of the electronic controller circuitry EC, the wireless communicator circuitry WC, the antenna circuitry 90, the power controller circuitry 92, and the informing circuitry 94 is not limited to the illustrated embodiment.

In the above embodiments and the modifications thereof, the circuit board 50 is a single circuit board. However, the circuit board 50 can include at least two separate circuit boards if needed or desired. In such modifications, at least one of the first electric switch SW1, the second electric switch SW2, and the third electric switch SW3 can be one of the at least two circuit boards while another of the first electric switch SW1, the second electric switch SW2, and the third electric switch SW3 can be another of the at least two circuit boards.

In the above embodiments and the modifications thereof, the operating device 10 includes the wireless communicator circuitry WC. However, the operating device 10 can include wired communicator circuitry instead of or in addition to the wireless communicator circuitry WC if needed or desired. For example, the wired communicator circuitry is configured to communicate with at least one electric device via an electric cable. In such modifications, the operating device 10 includes a connection port to which the electric cable is to be connected.

In the above embodiments and the modifications thereof, the operating device 10 includes the first electric switch SW1, the second electric switch SW2, and the third electric switch SW3. However, the operating device 10 can include another electric switch in addition to the first electric switch SW1, the second electric switch SW2, and the third electric switch SW3 if needed or desired.

In the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. An operating device of a human-powered vehicle, the operating device comprising:
a base structure mountable to the human-powered vehicle;
a circuit board including a first surface and a second surface provided on a reverse side of the first surface;
a first operating member movably coupled to the base structure;
a second operating member movably coupled to the base structure;
a third operating member movably coupled to the base structure;
a first electric switch configured to be activated in response to a movement of the first operating member;
a second electric switch configured to be activated in response to a movement of the second operating member;
a third electric switch configured to be activated in response to a movement of the third operating member; and
the first electric switch, the second electric switch, and the third electric switch being provided on the circuit board.

2. The operating device according to claim 1, wherein
the first electric switch, the second electric switch, and the third electric switch are provided on the first surface.

3. The operating device according to claim 1, wherein
the first operating member is pivotally coupled to the base structure about a first pivot axis, and
the second operating member is pivotally coupled to the base structure about a second pivot axis.

4. The operating device according to claim 3, wherein
the second pivot axis is provided between the first electric switch and the second electric switch as viewed in a first direction perpendicular to the first surface.

5. An operating device of a human-powered vehicle, the operating device comprising:
a base structure mountable to the human-powered vehicle;
a circuit board including a first surface and a second surface provided on a reverse side of the first surface;
a first operating member movably coupled to the base structure;
a second operating member movably coupled to the base structure;
a third operating member movably coupled to the base structure;
a first electric switch configured to be activated in response to a movement of the first operating member;
a second electric switch configured to be activated in response to a movement of the second operating member;
a third electric switch configured to be activated in response to a movement of the third operating member; and
the first operating member is pivotally coupled to the base structure about a first pivot axis,
the second operating member is pivotally coupled to the base structure about a second pivot axis, and
the second pivot axis is provided between the first electric switch and the second electric switch as viewed in a first direction perpendicular to the first surface.

6. The operating device according to claim 3, wherein
the second pivot axis is provided between the second electric switch and the third electric switch as viewed in a first direction perpendicular to the first surface.

7. The operating device according to claim 3, wherein
the first electric switch is at least partially provided between the first pivot axis and the second pivot axis as viewed in a first direction perpendicular to the first surface.

8. The operating device according to claim 3, wherein
the third electric switch is at least partially provided between the first pivot axis and the second pivot axis as viewed in a first direction perpendicular to the first surface.

9. The operating device according to claim 3, wherein
the first pivot axis is spaced apart from the second pivot axis as viewed in a first direction perpendicular to the first surface.

10. The operating device according to claim 1, wherein
a first minimum distance is defined between the first electric switch and the third electric switch,
a second minimum distance is defined between the second electric switch and the third electric switch, and
the first minimum distance is different from the second minimum distance.

11. An operating device of a human-powered vehicle, the operating device comprising:
a base structure mountable to the human-powered vehicle;
a circuit board including a first surface and a second surface provided on a reverse side of the first surface;
a first operating member movably coupled to the base structure;
a second operating member movably coupled to the base structure;
a third operating member movably coupled to the base structure;
a first electric switch configured to be activated in response to a movement of the first operating member;
a second electric switch configured to be activated in response to a movement of the second operating member;
a third electric switch configured to be activated in response to a movement of the third operating member; and
a first minimum distance is defined between the first electric switch and the third electric switch,
a second minimum distance is defined between the second electric switch and the third electric switch, and
the first minimum distance is different from the second minimum distance.

12. The operating device according to claim 10, wherein
the first minimum distance is shorter than the second minimum distance.

13. The operating device according to claim 1, further comprising
a circuit board support, wherein
the circuit board is fastened to the circuit board support, and
the circuit board support is a separate member from the base structure.

14. The operating device according to claim 13, wherein
the circuit board support at least partially overlaps the circuit board as viewed in a first direction perpendicular to the first surface.

15. The operating device according to claim 13, wherein
the circuit board support is fastened to the second surface of the circuit board.

16. The operating device according to claim 13, further comprising
a support fastener configured to fasten the circuit board to the circuit board support.

17. The operating device according to claim 16, wherein
the circuit board support includes a support fastener hole, and
the support fastener is at least partially provided in the support fastener hole.

18. The operating device according to claim 16, wherein
the first operating member is pivotally coupled to the base structure about a first pivot axis,
the second operating member is pivotally coupled to the base structure about a second pivot axis, and
the support fastener is at least partially provided between the first pivot axis and the second pivot axis as viewed in a first direction perpendicular to the first surface.

19. The operating device according to claim 13, further comprising
a power source holder configured to hold an electric power source, wherein
the circuit board support is coupled to the power source holder.

20. The operating device according to claim 19, wherein
the power source holder is coupled to the base structure.

21. The operating device according to claim 19, wherein
the power source holder includes a holder body and a power source terminal,
the holder body is made of a non-metallic material,
the power source terminal is made of a metallic material, and
the circuit board support is coupled to the holder body.
